(19) United States
(12) Patent Application Publication
(10) Pub. No.: US 2015/0218353 A1
(43) Pub. Date: Aug. 6, 2015

(54) MOULDED ARTICLE WITH LOW WARPAGE

(71) Applicant: Borouge Compounding Shanghai Co., Ltd., Shanghai (CN)

(72) Inventors: Shengquan Zhu, Shanghai (CN); Aaron Wang, Shanghai (CN)

(73) Assignee: Borouge Compounding Shanghai Co., Ltd. a corporation

(21) Appl. No.: 14/401,647

(22) PCT Filed: May 22, 2012
(86) PCT No.: PCT/CN2012/075857

§ 371 Date: Apr. 23, 2015

(51) Int. Cl. C08L 23/12

(52) U.S. Cl. CPC C08L 23/12; C08L 2205/16

(57) ABSTRACT

Use of a composition comprising a propylene homopolymer; a non-spherical reinforcing material, phyllosilicate, and compatibilizer to reduce the warpage of injection molded articles.

The present invention is directed to a new moulded article with low warpage.

Polypropylene compositions are used in many molded articles. One problem of polypropylene in this technical field is that it shows warpage. Warpage occurs during cooling in an injection-molding process due to an uneven shrinkage triggered by the crystallization process of the polymer. This phenomenon is even more pronounced where polypropylene is mixed up with non-spherical reinforcement materials, like needle-like materials, to improve stiffness as well as the toughness behavior of said material.

Molded articles of reinforced polypropylene are widely used due to a good stiffness and especially due to the excellent stiffness/impact balance. This good balance can in particular achieved in cases the polypropylene is mixed with reinforcing material of non-spherical shape, like fibers. Such non-spherical reinforcing material is featured by a rather high aspect ratio.

However reinforced polypropylene material containing non-spherical reinforcing material has a drawback in injection-molding process. That is, the non-spherical reinforcing material orients along the molding direction in the liquid melt under high pressure and high speed. The orientation aggravates the uneven shrinkage during the cooling process leading to an enhanced warpage of the reinforced polypropylene material. The greater the size, the thinner the thickness and the article having a high size precession to be molded, the higher the possibility of warpage and more obvious the distortions are. This defect restricts greatly the application of the reinforced polypropylene material containing non-spherical reinforcing material, especially for fans, i.e. for fans in air-conditioners and the like. Once the warpage and distortion occur, the leaves of the fan generate an uneven wind flow, suffers from a higher energy-consumption, a larger noise, and a faster abrasion of axis. Accordingly a reinforced polypropylene material with reduced warpage is desired.

Therefore, it is the object of the present invention to find a composition which enables a skilled artisan to produced molded articles, like fans or at least leaves of fans, showing low or even no warpage. Preferably the other mechanical properties shall not suffer from the reduction of warpage.

The finding of the present invention is that the composition must comprise a propylene homopolymer with rather high melt flow rate MFR₂ (230° C.), i.e. with at least 5 g/10 min, a non-spherical reinforcing material and a phyllosilicate as well as a compatibilizer which improves the dispersement of the non-spherical reinforcing material.

Accordingly the invention is directed to a composition (Co) comprising
(a) a propylene homopolymer (H-PP) having a melt flow rate MFR₂ (230° C.) measured according to ISO 1133 of at least 5.0 g/10 min, preferably of at least 10.0 g/10 min;
(b) a non-spherical reinforcing material (RF);
(c) a phyllosilicate (P); and
(d) a compatibilizer (C).

The invention is in particular directed to a moulded article comprising a composition (Co), wherein said composition comprises
(a) a propylene homopolymer (H-PP) having a melt flow rate MFR₂ (230° C.) measured according to ISO 1133 of at least 5.0 g/10 min, preferably of at least 10.0 g/10 min;
(b) a non-spherical reinforcing material (RF);
(c) a phyllosilicate (P); and
(d) a compatibilizer (C).

Especially good results are achievable for the composition (Co) as such as well as for the moulded article comprising said composition (Co), in case the composition (Co) comprises
(a) 50 to 80 wt.-% of the propylene homopolymer (H-PP);
(b) 10 to 30 wt.-% of the non-spherical reinforcing material (RF);
(c) 5 to 25 wt.-% of the phyllosilicate (P); and
(d) 0.5 to 5 wt.-% of the compatibilizer (C);
based on the total amount of the composition (Co).

It has surprisingly found that such a composition (Co) leads to moulded articles, especially injection moulded articles, which combine good mechanical properties in terms of stiffness and toughness with low warpage.

In the following the invention will be described in more detail. First the composition (Co) including its components is described and subsequent the moulded article comprising said composition (Co).

### The Composition (Co)

As mentioned above the inventive composition must comprise different components namely at least a propylene homopolymer (H-PP), a non-spherical reinforcing material (RF), and a phyllosilicate (P). Preferably the composition comprises in addition a compatibilizer (C).

Accordingly it is appreciated that the instant composition (Co) comprises
(a) 50 to 80 wt.-%, more preferably in the range of 55 to 70 wt.-%, still more preferably in the range of 55 to 65 wt.-%, of the propylene homopolymer (H-PP);
(b) 10 to 30 wt.-%, more preferably in the range of 15 to 30 wt.-%, still more preferably in the range of 20 to 30 wt.-%, like in the range of 23 to 28 wt.-%, of the non-spherical reinforcing material (RF);
(c) 5 to 25 wt.-%, more preferably in the range of 5 to 18 wt.-%, still more preferably in the range of 8 to 15 wt.-%, like in the range of 10 to 15 wt.-%, of the phyllosilicate (P); and
(d) 0.5 to 5 wt.-%, more preferably in the range of 0.5 to 3 wt.-%, still more preferably in the range of 1.0 to 3.0 wt.-%, like in the range of 1.5 to 2.5 wt.-% or in the range of 1.8 to 2.3 wt.-%, of the compatibilizer (C);
based on the total amount of the composition (Co).

Like in other polymer composition, the instant composition (Co) may comprise also typical additives (A). The total amount of additives shall preferably not exceed 4 wt.-% and is preferably in the range of 0.2 to 4 wt.-% based on the total amount of the composition (Co). The additives (A) may included into the composition (Co) in form of a one-package, which comprises the additives (A) and a polyolefin (PO) as a carrier of additives. In such a case the instant composition (Co) may comprise additionally a polyolefin (PO) up to 2 wt.-%, i.e. from 0.5 to 1.5 wt.-%, based on the total weight of the composition (Co).

Accordingly in one preferred embodiment the composition (Co) comprises as polymer components only the propylene homopolymer (H-PP), the compatibilizer (C), and optionally the polyolefin (PO). In other words the composition (Co) may comprise further non-polymeric components but no other polymers as the propylene homopolymer (H-PP), the compatibilizer (C) and the polyolefin (PO).

In one specific embodiment the composition (Co) consist of the propylene homopolymer (H-PP), the non-spherical reinforcing material (RF), the phyllosilicate (P), the compatibilizer (C), the additives (A) and optionally the polyolefin (PO).

The instant composition (Co) preferably has a melt flow rate MFR2 (230° C.) of at least 3.0 g/10 min, more preferably in the range of 3.0 to 20.0 g/10 min, still more preferably in the range of 4.0 to 15.0 g/10 min, yet more preferably in the range of 4.5 to 10.0 g/10 min, still yet more preferably in the range of 6.0 to 10.0 g/10 min, like in the range of 6.5 to 10.0 g/10 min.

The instant composition (Co) can be further defined by its mechanical properties. Thus it is appreciated that the composition (Co) has
(a) a flexural modulus measured according to ISO 178 (80×10×4 mm³ injection moulded specimen) of equal or more than 4,000 MPa, more preferably of equal or more than 5,000 MPa, still more preferably equal or more than 6,400 MPa, yet more preferably in the range of 4,000 to 7,900 MPa, still yet more preferably in the range of 5,000 to 7500 MPa, like in the range of 6,000 to 7,500 MPa, most preferably in the range of 6,400 to 7,500 MPa or in the range of 7,100 to 7,500 MPa, and/or
(b) tensile strength measured according to ISO 527-2 (cross head speed=50 mm/min; 23° C.) of equal or more than 50 MPa, more preferably of equal or more than 60 MPa, still more preferably in the range of 50 to 101 MPa, yet more preferably in the range of 60 to 95 MPa, still yet more preferably in the range of 70 to 95 MPa, like in the range of 80 to 95 MPa,
and/or
(c) an Izod impact strength measured according to ISO 180/1 Å (at 23 C; 80×10×4 mm³ injection moulded specimen) of equal or more than 4.6 kJ/m², more preferably of equal or more than 6.0 kJ/m², still more preferably in the range of 4.6 to 14.0 kJ/m², yet more preferably in the range of 6.0 to 14.0 kJ/m², yet more preferably in the range of 8.0 to 12.0 kJ/m², like yet more preferably in the range of 10.0 to 12.0 kJ/m².

For mixing the individual components of the composition (Co), a conventional compounding or blending apparatus, e.g. a Banbury mixer, a 2-roll rubber mill, Buss-co-kneader or a twin screw extruder may be used. Preferably, mixing is accomplished in a co-rotating twin screw extruder. Preferably the non-spherical reinforcing material (RF) is fed via a side feeder, whereas the other components are fed via the main feeder at the front feeding end of the extruder into the extruder. The side feeder is preferably located downstream to the main feeder. The polymer materials recovered from the extruder are usually in the form of pellets. These pellets are then preferably further processed, e.g. by molding, like injection molding, to generate (injection) molded articles as defined in more detail below.

In the following the individual components of the composition (Co) are discussed in more detail.

### The Propylene Homopolymer (H-PP)

The term “propylene homopolymer (H-PP)” is broadly understood and thus covers also embodiments in which different homopolymers are mixed. More precisely the term “propylene homopolymer (H-PP)” may also cover embodiments in which two or more, like three, propylene homopolymers are mixed which differ in their melt flow rate. Accordingly in one embodiment the term “propylene homopolymer (H-PP)” covers just one propylene homopolymer with one specific melt flow rate, preferably in the range as defined below. In another embodiment the term “propylene homopolymer (H-PP)” stands for a mixture of two or three, preferably two, propylene homopolymers, which differ in their melt flow rate. Preferably the two or three propylene homopolymers have a melt flow rate as in the range as defined below. According to this invention the melt flow differ from each other if the difference between the melt flow rates MFR₂ (230° C.) of two propylene homopolymers is at least 5 g/10 min, preferably at least 10 g/10 min, like at least 15 g/10 min.

The expression propylene homopolymer as used throughout the instant invention relates to a polypropylene that consists substantially, i.e. of more than 99.5 wt.-%, still more preferably of at least 99.7 wt.-%, like of at least 99.8 wt.-%, of propylene units. In a preferred embodiment only propylene units in the propylene homopolymer are detectable.

The propylene homopolymer (H-PP) according to this invention must have a melt flow rate MFR₂ (230° C.) of at least 5.0 g/10 min, preferably of at least 10 g/10 min, more preferably in the range of 5.0 to 80.0 g/10 min, more preferably in the range of 10 to 50 g/10 min, still more preferably in the range of 15 to 30 g/10 min, yet more preferably in the range of 20 to 30 g/10 min.

The propylene homopolymer (H-PP) is preferably an isotactic propylene homopolymer. Accordingly it is appreciated that the propylene homopolymer (H-PP) has a rather high pentad concentration, i.e. higher than 90 mol-%, more preferably higher than 92 mol-%, still more preferably higher than 93 mol-% and yet more preferably higher than 95 mol-%, like higher than 99 mol-%.

Preferably the propylene homopolymer (H-PP) has a melting temperature Tm measured according to ISO 11357-3 of at least 150° C., more preferably of at least 155° C., more preferably in the range of 150 to 168° C., still more preferably in the range of 155 to 165° C.

Further the propylene homopolymer (H-PP) has a rather low xylene cold soluble (XCS) content, i.e. below 4.5 wt.-%, more preferably below 4.0 wt.-%, yet more preferably below 3.7 wt.-%. Thus it is appreciated that the xylene cold soluble (XCS) content is in the range of 0.5 to 4.5 wt.-%, more preferably in the range of 1.0 to 4.0 wt.-%, yet more preferably in the range of 1.5 to 3.5 wt.-%.

The propylene homopolymer (H-PP) suitable in the inventive composition (Co) is available from a wide variety of commercial sources and can be produced as known from the art. For instance the propylene homopolymer (H-PP) can be produced in the presence of a single-site catalyst or a Ziegler-Natta catalyst, the latter being preferred.

The polymerization of the propylene homopolymer (H-PP) can be a bulk polymerization, preferably performed in a so-called loop reactor. Alternatively, the polymerization of the propylene homopolymer (H-PP) is a two stage or more stage polymerization performed in a combination of a loop reactor operating in slurry phase and one or more gas phase reactors as for instance applied in the Borstar® polypropylene process.

Preferably, in the process for producing the propylene homopolymer (H-PP) as defined above the conditions for the bulk reactor of step may be as follows:
the temperature is within the range of 40° C. to 110° C., preferably between 60° C. and 100° C., 70 to 90° C.,
the pressure is within the range of 20 bar to 80 bar, preferably between 30 bar to 60 bar,
hydrogen can be added for controlling the molar mass in a manner known per se.

Subsequently, the reaction mixture from the bulk (bulk) reactor can be transferred to the gas phase reactor, whereby the conditions are preferably as follows:
the temperature is within the range of 50° C. to 130° C., preferably between 60° C. and 100° C.,
the pressure is within the range of 5 bar to 50 bar, preferably between 15 bar to 35 bar,
hydrogen can be added for controlling the molar mass in a manner known per se.

The residence time can vary in both reactor zones. In one embodiment of the process for producing the propylene polymer the residence time in bulk reactor, e.g. loop is in the range 0.5 to 5 hours, e.g. 0.5 to 2 hours and the residence time in gas phase reactor will generally be 1 to 8 hours.

If desired, the polymerization may be effected in a known manner under supercritical conditions in the bulk, preferably loop reactor, and/or as a condensed mode in the gas phase reactor.

As mentioned above, the propylene homopolymer (H-PP) is preferably obtained using a Ziegler-Natta system.

Accordingly the process as discussed above is carried out using a Ziegler-Natta catalyst, in particular a high yield Ziegler-Natta catalyst (so-called fourth and fifth generation type to differentiate from low yield, so called second generation Ziegler-Natta catalysts). A suitable Ziegler-Natta catalyst to be employed in accordance with the present invention comprises a catalyst component, a co-catalyst component and at least one electron donor (internal and/or external electron donor, preferably at least one external donor). Preferably, the catalyst component is a Ti—Mg-based catalyst component and typically the co-catalyst is an Al-alkyl based compound. Suitable catalysts are in particular disclosed in U.S. Pat. No. 5,234,879, WO 92/19653, WO 92/19658 and WO 99/33843.

Preferred external donors are the known silane-based donors, such as dicyclopentyl dimethoxy silane, diethylamino triethoxy silane or cyclohexyl methyldimethoxy silane.

If desired the Ziegler-Natta catalyst system is modified by polymerizing a vinyl compound in the presence of the catalyst system, wherein the vinyl compound has the formula:

CH₂═CH—CHR³R⁴

wherein R³ and R⁴ together form a 5- or 6-membered saturated, unsaturated or aromatic ring or independently represent an alkyl group comprising 1 to 4 carbon atoms. The so modified catalyst is used if desired for the preparation of the propylene homopolymer (H-PP) to accomplish α-nucleation of the polymer, the composition (Co) and thus of the total molded article (BNT-technology).

One embodiment of a process for the propylene homopolymer (H-PP), as discussed above, is a loop phase process or a loop-gas phase process, such as developed by Borealis, known as Borstar® technology, described for example in EP 0 887 379 A1 and WO 92/12182.

### The Non-Spherical Reinforcing Material (RF)

Reinforcing materials are known in the art. They are used to enhance stiffness of polymer compositions. To obtain especially good results the reinforcing material (RF) is rather of longitudinal shape than of round shape. Accordingly the reinforcing material (RF) is of non-spherical shape, preferably is of fibrous shape, even more preferred the reinforcing material (RF) is a fiber.

The term “non-spherical reinforcing material (RF)” according to this invention shall in particular exclude phyllosilicates. Thus, according to this invention the terms “non-spherical reinforcing material (RF)” and “phyllosilicate” define different materials and are not interchangeable. Hence the non-spherical reinforcing material (RF) is preferably selected from the group consisting of glass fiber (GF), carbon fiber (CF), and wollastonite (WL), more preferably the non-spherical reinforcing material (RF) is a glass fiber (GF) or a carbon fiber (CF). In one preferred embodiment the preferably non-spherical reinforcing material (RF) is a glass fiber (GF), like a E-glass fiber (E-GF). The glass fiber (GF) may be either a cut glass fiber or long glass fiber, although preference is given to using cut a glass fiber, also known as short fiber or chopped strand. Typically the glass fibers (GF) are surface treated with components like sizes, lubricants, or coupling agents. Preferably the glass fiber (GF) according to this invention is treated with sizes, like organosilanes and/or water-soluble polymers. Such surface treatment is known to the skilled person. Reference in this regard is made for instance to the textbook “Plastic Additives” (Gachter/Müller; 3^{rd} edition).

It is preferred that the non-spherical reinforcing material (RF), preferably the glass fiber (GF) or carbon fiber (CF), especially the glass fiber (GF), has a rather high aspect ratio. The aspect ratio according to this invention is the relation between length and diameter of the non-spherical reinforcing material (RF), preferably of the glass fiber (GF) or carbon fiber (CF), especially of the glass fiber (GF).

Preferably, the non-spherical reinforcing material (RF), preferably of the glass fiber (GF) or carbon fiber (CF), especially the glass fiber (GF), has an aspect ratio in the range of 5 to 400, more preferably in the range of 15 to 350, still more preferably in the range of 25 to 300, yet more preferably in the range of 50 to 200.

Preferably non-spherical reinforcing material (RF), preferably the glass fiber (GF) or carbon fiber (CF), especially the glass fiber (GF), has a length in the range of 0.1 to 3.0 mm, more preferably in the range of 0.3 to 2.0 mm, yet more preferably in the range of 0.5 to 1.5 mm, still yet more preferably in the range of 0.9 to 1.5 mm.

The diameter of the non-spherical reinforcing material (RF), preferably of the glass fiber (GF) or carbon fiber (CF), especially of the glass fiber (GF), is in the range of 8 to 20 μm, more preferably from 9 to 15 μm or 9 to 14 μm.

### The Phyllosilicate (P)

As mentioned above the phyllosilicate (P) according to this invention is different to the non-spherical reinforcing material (RF).

Preferably the phyllosilicate (P) is selected from the group consisting of mica, kaolinite, montmorillonite, talc, and mixtures thereof. More preferably the phyllosilicate (P) is selected from the group consisting of mica, talc, and mixtures thereof. In one preferred embodiment the phyllosilicate (P) is talc or mica, especially mica.

Preferably the phyllosilicate (P), like the mica or the talc, is in the form of flakes and/or particles, more preferably in the form of flakes. In one specific embodiment the phyllosilicate (P) is a flaky mica.

In one preferred embodiment the phyllosilicate (P), preferably of the mica, has a cutoff particle size d95 [mass percent] determined by sedimentation technique of in the range of 3.5 to 50.0 μm, more preferably in the range of 5.0 to 40.0 μm, like in the range of 10.0 to 35.0 μm.

### The Compatibilizer (C)

To improve compatibility between the propylene homopolymer (H-PP) on the one hand and the non-spherical reinforcing material (RF) and the phyllosilicate (P) on the other hand a compatibilizer (C) is used.

The compatibilizer (C) preferably comprises a modified (functionalized) polymer having polar groups. Modified α-olefin polymers, in particular propylene homopolymers and copolymers, like copolymers of ethylene and propylene or other α-olefins, are most preferred, as they are highly compatible with the polymers of the composition (Co). Modified polyethylene can be used as well but is less preferred.

In terms of structure, the modified polymers are preferably selected from graft or block copolymers.

In this context, preference is given to modified polymers containing groups deriving from polar compounds, in particular selected from the group consisting of acid anhydrides, carboxylic acids, carboxylic acid derivatives, primary and secondary amines, hydroxyl compounds, oxazoline and epoxides, and also ionic compounds.

Specific examples of the said polar compounds are unsaturated cyclic anhydrides and their aliphatic diesters, and the diacid derivatives. In particular, one can use maleic anhydride and compounds selected from C₁ to C₁₀ linear and branched dialkyl maleates, C₁ to C₁₀ linear and branched dialkyl fumarates, itaconic anhydride, C₁ to C₁₀ linear and branched itaconic acid dialkyl esters, maleic acid, fumaric acid, itaconic acid and mixtures thereof.

Particular preference is given to using a propylene polymer grafted with maleic anhydride as the modified polymer, i.e. the compatibilizer (C).

The modified polymer, i.e. the compatibilizer (C), can be produced in a simple manner by reactive extrusion of the polymer, for example with maleic anhydride in the presence of free radical generators (like organic peroxides), as disclosed for instance in EP 0 572 028.

Preferred amounts of groups deriving from polar compounds in the modified polymer, i.e. in the compatibilizer (C), are from 0.5 to 4. wt.-%, more preferably from 0.5 to 2.0 wt.-%, like from 0.9 to 2.0 wt.-%.

Preferred values of the melt flow rate MFR₁ (190° C.) for the modified polymer, i.e. for the compatibilizer (C), are from 1.0 to 500 g/10 min, preferably from 5 to 400 g/10 min, more preferably from 10 to 300 g/10 min, still more preferably in the range of 50 to 280 g/10 min, yet more preferably in the range of 70 to 250 g/10 min.

### The Additives (A)

According to this invention the term “additive (A)” does not cover the phyllosilicates (P) and the non-spherical reinforcing material (RF) as defined herein. Accordingly it is preferred that the additives (A) are selected from the group consisting of antioxidants, UV-stabilizers, slip agents, antistatic agents, demolding agents, nucleating agents, like α-nucleating agents, and mixtures thereof. The total amount of additives shall preferably not exceed 4 wt.-% and is preferably in the range of 0.1 to 4.0 wt.-%, more preferably in the range of 0.2 to 3.0, still more preferably in the range of 0.5 to 3.0, yet more preferably in the range of 0.5 to 2.0, like in the range of 0.5 to 1.0 wt.-%, based on the total amount of the composition.

Preferably the additives (A) are provided as a one-package. Said one-package preferably comprises in addition to the additives a carrier being preferably a polyolefin (PO).

In view of the use of α-nucleating agents the following should be mentioned. In principle any α-nucleating agent can be used. Examples of especially suitable α-nucleating agents are selected from the group consisting of
(i) salts of monocarboxylic acids and polycarboxylic acids, e.g. sodium benzoate or aluminum tert-butylbenzoate, and
(ii) dibenzylidenesorbitol (e.g. 1,3:2,4 dibenzylidenesorbitol) and C₁-C₈-alkyl-substituted dibenzylidenesorbitol derivatives, such as methyldibenzylidenesorbitol, ethyldibenzylidenesorbitol or dimethyldibenzylidenesorbitol (e.g. 1,3:2,4 di(methylbenzylidene) sorbitol), or substituted nonitol-derivatives, such as 1,2,3,-trideoxy-4,6:5,7-bis-O-[(4-propylphenyl)methylene]-nonitol, and
(iii) salts of diesters of phosphoric acid, e.g. sodium 2,2′-methylenebis(4,6,-di-tert-butylphenyl) phosphate or aluminium-hydroxy-bis[2,2′-methylene-bis(4,6-di-t-butylphenyl)phosphate], and
(iv) vinylcycloalkane polymer and vinylalkane polymer (as discussed above), and
(v) mixtures thereof.

However it is preferred that the α-nucleating agent is in particular selected from the group consisting of
(i) salts of monocarboxylic acids and polycarboxylic acids, e.g. sodium benzoate or aluminum tert-butylbenzoate,
(ii) dibenzylidenesorbitol (e.g. 1,3:2,4 dibenzylidenesorbitol) and C₁-C₈-alkyl-substituted dibenzylidenesorbitol derivatives, such as methyldibenzylidenesorbitol, ethyldibenzylidenesorbitol or dimethyldibenzylidenesorbitol (e.g. 1,3:2,4 bis(dimethylbenzylidene) sorbitol),
(iii) substituted nonitol-derivatives, such as 1,2,3,-trideoxy-4,6:5,7-bis-O-[(4-propylphenyl)methylene]-nonitol,
(iv) salts of diesters of phosphoric acid, e.g. sodium 2,2′-methylenebis(4,6,-di-tert-butylphenyl) phosphate or aluminium-hydroxy-bis[2,2′-methylene-bis(4,6-di-t-butylphenyl)phosphate], like aluminium-hydroxy-bis[2,2′-methylene-bis(4,6-di-tert-butylphenyl)phosphate]and Li-myristate (NA21),
(v) trisamide-benze derivatives, i.e. N-[3,5-bis-(2,2-dimethyl-propionylamino)-phenyl]-2,2-dimethyl-propionamide,
(vi) vinylcycloalkane polymer and vinylalkane polymer, and
(vii) mixtures thereof.

In a specific embodiment α-nucleating agents as listed under (ii), (iii), (iv), (vi) or of the previous paragraph are used.

Such additives are generally commercially available and are described, for example, in “Plastic Additives Handbook”, 5th edition, 2001 of Hans Zweifel.

The α-nucleating agent content of the propylene homopolymer (H-PP) is preferably up to 5.0 wt.-% and thus in the composition (Co) composition up to 4 wt.-%. In a preferred embodiment, the propylene homopolymer (H-PP) (consequently the amount in the composition (Co) is correspondingly lower) contains from equal or below 0.0001 to equal or below 1.0 wt.-%, more preferably from 0.0005 to 1.0 wt.-%, yet more preferably from 0.01 to 1.0 wt.-%, of a α-nucleating agent, in particular selected from the group consisting of dibenzylidenesorbitol (e.g. 1,3:2,4 dibenzylidene sorbitol), dibenzylidenesorbitol derivative, preferably dimethyldibenzylidenesorbitol (e.g. 1,3:2,4 di(methylbenzylidene) sorbitol), or substituted nonitol-derivatives, such as 1,2,3,-trideoxy-4,6:5,7-bis-O-[(4-propylphenyl)methylene]-nonitol, vinylcycloalkane polymer, vinylalkane polymer, and mixtures thereof. It is especially preferred that the of the propylene homopolymer (H-PP) contains a vinylcycloalkane, like vinylcyclohexane (VCH), polymer and/or vinylalkane polymer.

Typically these additives (A) or part of the additives (A) are included into the composition (Co) in form of an one-package which includes the additives (A) and the polyolefin (PO) as a carrier for the additives. The term one-package according to this invention is understood as known in the art. Accordingly the term one-package preferably indicates that the amount of the total amount of additives (A) in the one-package is higher compared to the total amount of the additives (A) in the end composition (Co). In a preferred embodiment, the sum of amounts of additives (A) and polyolefin (PO) is an integer from 1 to 5 in wt.-%, preferably an integer from 2 to 4 in wt.-%, based on the total weight of the composition.

Preferably the polyolefin (PO) of the one-package is a polyethylene or a polypropylene, the latter preferred.

### Molded Articles and Use

The instant composition (Co) of the present invention is preferably used for the production of molded articles in particular injection molded articles. Preferably the molded articles, in particular injection molded articles, shall comply with the requirement of high size precision.

The term “moulded” according to this invention is broadly understood and thus cover articles obtained by any kind of forming processes via moulding. The terms “moulding” or “moulded” in particular covers injection moulded articles. In the injection moulding process the moulding material is fed into a heated barrel (where it is heated up and moulded) and forced into a mould cavity of a mould where it cools down under pressure. Reference with regard to the definitions of extrusion and moulding is made to the “Polypropylene Handbook”, Nello Pasquini, 2^{nd} Edition, Hanser. The injection moulding process is preferred and thus the invention is in particular directed to injection moulded articles.

Accordingly, the present invention also provides molded articles, like injection molded articles, comprising at least 85 wt.-%, like 85 to 100 wt.-%, preferably at least 90 wt.-%, like 90 to 100 wt.-% of the composition of the present invention. Accordingly the molded article, like the injection molded article may comprise other components like polyolefin elastomers (such as elastomer copolymers of propylene and ethylene), polyethylenes, and the like. In one specific embodiment the molded articles, like injection molded articles, consists of the instant composition (Co). Thus the present invention is directed to (injection) molded articles selected from the group consisting of fans, parts of a fan, housings of a generator, housings of an air duct, plastic plates, cover plates, such as a cover plate of a table, base plates, backrests, and plastic chairs comprising at least 85 wt.-%, like 85 to 100 wt.-%, preferably at least 90 wt.-%, like 90 to 100 wt.-% and most preferably consisting of the instant composition (Co). More preferably the present invention is especially directed to (injection molded) (injection) molded articles being fans or parts of a fan, like leaves of the fan, comprising 85 wt.-%, like 85 to 100 wt.-%, preferably at least 90 wt.-%, like 90 to 100 wt.-% and most preferably consisting of the instant composition (Co). The fan, such as centrifugal fans and axial fans, or the part of the fan, like the leave of the fan, is preferably used for air-conditioners and fanners, more preferably for indoor or outdoor air conditioner.

The present invention is further directed to the use of the instant composition in (injection) molded articles to reduce the warpage of said articles, wherein preferably the warpage defined as the δ-warpage is preferably equal or below 2.6 mm, more preferably is in the range of 0.1. to 2.2 mm, still more preferably in the range of 0.5 to 1.2 mm, like in the range of 0.5 to 1.1 mm.

The present invention will now be described in further detail by the examples provided below.

### EXAMPLES

### 1. Measuring Methods

The following definitions of terms and determination methods apply for the above general description of the invention as well as to the below examples unless otherwise defined.

### Quantification of Isotacticity in Polypropylene by ¹³C NMR Spectroscopy

The isotacticity is determined by quantitative ¹³C nuclear magnetic resonance (NMR) spectroscopy after basic assignment as e.g. in: V. Busico and R. Cipullo, Progress in Polymer Science, 2001, 26, 443-533. Experimental parameters are adjusted to ensure measurement of quantitative spectra for this specific task as e.g. in: S. Berger and S. Braun, 200 and More NMR Experiments: A Practical Course, 2004, Wiley-VCH, Weinheim. Quantities are calculated using simple corrected ratios of the signal integrals of representative sites in a manner known in the art. The isotacticity is determined at the pentad level i.e. mmmm fraction of the pentad distribution.

Density is measured according to ISO 1183-187. Sample preparation is done by compression molding in accordance with ISO 1872-2:2007

Melting temperature Tm is measured according to ISO 11357-3

MFR₂ (230° C.) is measured according to ISO 1133 (230° C., 2.16 kg load).

MFR₁ (190° C.) is measured according to ISO 1133 (190° C., 1.2 kg load).

### Quantification of Comonomer Content by FTIR Spectroscopy

The comonomer content is determined by quantitative Fourier transform infrared spectroscopy (FTIR) after basic assignment calibrated via quantitative ¹³C nuclear magnetic resonance (NMR) spectroscopy in a manner well known in the art. Thin films are pressed to a thickness of between 100-500 μm and spectra recorded in transmission mode. Specifically, the ethylene content of a polypropylene-co-ethylene copolymer is determined using the baseline corrected peak area of the quantitative bands found at 720-722 and 730-733 cm⁻¹ Quantitative results are obtained based upon reference to the film thickness.

The content of xylene cold solubles (XCS, wt.-%) was determined at 25° C. according to ISO 16152; first edition; Jan 7, 2005.

Flexural Modulus was determined in 3-point-bending at 23° C. according to ISO 178 on 80×10×4 mm³ test bars injection moulded in line with EN ISO 1873-2.

Tensile strength is measured according to ISO 527-2 (cross head speed=50 mm/min; 23° C.) using injection molded specimens as described in EN ISO 1873-2 (dog bone shape, 4 mm thickness).

Izod notched impact strength is determined according to ISO 180/1 Å at 23° C. by using injection molded test specimens as described in EN ISO 1873-2 (80×10×4 mm).

### Average Fiber Diameter:

Determined according to ISO 1888:2006(E), Method B, microscope magnification of 1000.

Fiber length has been measured by vernier caliper

Aspect Ratio is the relation between length (L) and diameter (D) of the fiber (L[mm]/D[mm])

Cutoff particle size d95 (Sedimentation) is calculated from the particle size distribution [mass percent] as determined by gravitational liquid sedimentation according to ISO 13317-3 (Sedigraph)

### Warpage

### δ-Warpage

Sample sheets for measuring warpage are prepared by using an injection-molding machinery. The sample sheets are in the form of an oblong sheet (300×150×2 mm) Before the test, the molded samples are conditioned by exposing them for 24 hours after injection-molding a test atmosphere (23° C., 50% humidity). A sample sheet to be tested is placed on a level and smooth surface of a wood table, and it is observed whether a warpage occurs by naked eyes. If all of four sides and four corners of the oblong sheet fit well with the surface of the table and no any gap between the sides or corners and the surface, it means no warpage occurs. If any one of four sides and four corners does not fit well with the surface of the table, it means the warpage occurs. In this case, the gap between top point of the warped side or warped corner and the surface of the table is measured by a vernier caliper, and is recorded. If more than one side or corner of the sample sheet warped, each gap between each warped side or each warped corner and the surface of the table is measured, and the greatest gap is recorded as a representative of the warpage of this sample sheet. For one composition for injection-molding, five molded sample sheets are measured, and an average of the measured values of the five sheets is taken as δ, which represents the warpage of the molded sheet of the composition.

### ΔH Warpage

### Measure Method of the Warpage of a Molded Fan of Air-Conditioner

Usually an air conditioner fan has three or four leaves. The warpage of the fan is actually the warpage of the leaves that can be indicated by a deviation amplitude of actual height of a leaf to the desired height of the leaf as fixed by the mold for the fan. The actual height of each leaf is measured, and the deviation amplitude of the height of each leaf is calculated.

Maximum of the height deviation amplitude among all leaves is recorded as ΔH1, which represents the warpage of the molded fan of air-conditioner.

Measure method of the warpage of a molded housing of a generator: The housing of a generator is oblong with a length, a width and a height, and has an oblong upper surface. The warpage of the housing can be indicated by a deviation amplitude of actual height of central point in the oblong upper surface to the desired height of the central point as fixed by the mold for the housing. The height of center point in the oblong upper surface means a distance from the center point vertically to bottom plane of the housing. The height deviation amplitude of the central point is recorded as ΔH2, which represents the warpage of the molded housing of a generator.

Before the test, the fan is placed in a test atmosphere (23° C., 50% humidity) for 24 h after injection-molding.

### 2. Examples

Formulations of the compositions of the inventive examples 1 to 18 are shown in Table 1a and 1b.

For the preparation of compositions of the examples a Coperion STS-35 twin-screw extruder (available from Coperion (Nanjing) Corporation, China) is used with a diameter of 35 mm. The twin screw extruder runs at an average rotation rate of 400 rpm with a temperature profile of zones from 200° C. to 225° C. The throughput and the screw speed of the extruder for preparing compositions are listed in Table 3.

The temperature of each zone, throughput and screw speed of the extruder are initiative parameters, and are set on control panel of the extruder. Melt temperature (temperature of the melt in the die) and torque of the extruder are passive parameters shown on control panel of the extruder. A vacuum bump locates in zone 9 and generates a vacuum of −0.06 MPa inside the extruder.

All components of the composition of present invention except for the non-spherical reinforcing material are fed into the extruder at the feeding end of the extruder (i.e. zone 1 of the extruder). A side feeder locates in zone 7 for feeding the non-spherical reinforcing material into the extruder. The components of the composition are heated and mixed through zone 1-11 of the extruder, and is granulated through die head of the extruder. For the preparation of a molded specimen for measuring mechanical properties and a molded sheet for measuring the warpage an injection-molding machine, Victory 120 available from Engel Machinery (Shanghai) Ltd, is used to prepare regular test samples for measuring tensile property, flexural property, and impact property. The injection-molding machine includes a single-screw plasticizing part and an injection part. The single-screw plasticizing part includes 3 heating zones. The injection part includes a nozzle and a mold. For preparing regular test samples for measurement of mechanical properties, the mold is a regular one having an inner hollow cavity with a shape as indicated in the standards mentioned above. The pellets of the composition of each example obtained by the extruder as mentioned above are fed into the injection-molding machine. The pellets are heated, molten and mixed in the 3 heating zones, and then injected through the nozzle into the mold to form the test samples for measuring mechanical properties.

The above mentioned injection-molding machine is also used to prepare the molded sample sheets for measuring the δ-warpage, but the mold is replaced with a different one, which is suitable for preparing test samples for the warpage. The dimensions and shape of inner hollow cavity of the mold are identical to that of the sample sheets as indicated where the δ-warpage is defined.

The pellets of the composition of each example obtained by the extruder as mentioned above are fed into the injection-molding machine. The pellets are heated, molten and mixed in the 3 heating zones, and then injected through the nozzle into the hollow cavity of the mold. The processing parameters in injection-molding the molded specimen for measuring mechanical property in each example and comparison example are listed in Table 4. The processing parameters in injection-molding the sheet for measuring δ-warpage in each example and comparative example are listed in Table 5. The mechanical properties of the molded specimen and δ-warpage of the molded sheets are measured according to the measure method as mentioned above, and shown in Table 2.

In inventive examples 6, 16 and 18 and comparative example 1, the molded axial fans of outer air-conditioners are prepared. Further, the molded housings of a generator are prepared in inventive examples 6, 16 and 18, and comparative example.

An injection-molding machine, model HTF8000 available from Hai Tian Plastics Machinery (Ningbo, China), is used to prepare the molded fan and housing. The injection-molding machine includes a single-screw plasticizing part and an injection part. The single-screw plasticizing part includes 5 heating zones. The injection part includes a nozzle and a mold. The mold for molding the fan of outer air-conditioner, model 0010206805 available from Qingdao Hongming Plastics Inc. (Qingdao, China), is a single cavity mould with one main gate at central position. It has an inner hollow cavity, which has a pattern with an enantiomorphous shape and size to external surface to the fan. The fan has a total diameter of 400 mm. It includes a center axis and three leaves. The center axis has a shape of equilateral triangle with three circular angles, and each side of the equilateral triangle has a length of 90 mm. The center axis has a thickness of 45 mm Each leaf is a blade with a wide root, inner arc side and outer arc side inclining to the center axis, and a top point formed by intersection point of the two arc sides. Bottom side of the root of three leaves all locate completely in one plane, and constitute bottom plane of the fan. The leaf has an average thickness of 2.5 mm, and a wide root with a width of 175 mm Each leaf connects the center axis by a part of the inner arc side (a length of 85 mm) attaching to one side of equilateral triangle respectively in a slant angle of 30° relative to bottom plane of the fan. The top point of each leaf has the same height of 125 mm vertically to the bottom plane of the fan. The center axis has a height of 25 mm from bottom side itself to the bottom plane of the fan. The center axis has a spindle sleeve at the center of the equilateral triangle, which has an outer diameter of 14 mm, and an inner diameter of 8 mm, for receiving a driving shaft of an engine. The spindle sleeve has three reinforcement slabs extending from outer peripheral of the sleeve to three circular angles of equilateral triangle of the center axis respectively.

The housing molded in inventive examples 6, 16, 18 and comparative example is for a digital generator Pro3600Si available from Suzhou Boliy Power Co. Ltd (Suzhou, China). The mold for molding the housing of generator is also available from Suzhou Boliy Power Co. Ltd (Suzhou, China). The mold has an inner hollow cavity having a pattern with an enantiomorphous shape and size to external surface of generator Pro3600Si. The housing for digital generator Pro3600Si is oblong with a length of 550 mm, a width of 380 mm, and a height of 60 mm, and has an oblong upper surface.

The pellets of the compositions of inventive examples 6, 16 and 18 and comparative example obtained by the extruder as mentioned above are fed into the injection-molding machine with the mold for the fan for preparing the fan. The pellets are heated, molten and mixed in the 5 heating zones, and then injected through the nozzle into the hollow cavity of the mold to form the fan with the desired shape and size as mentioned above. The processing parameters in injection-molding the fan in inventive examples 6, 16 and 18 and comparative example are listed in Table 6.

Similarly, the pellets of the compositions of inventive examples 6, 16 and 18 and comparative example are fed into the injection-molding machine with the mold for the housing of digital generator Pro3600Si to prepare the housings respectively. The processing parameters in injection-molding the housings are listed in Table 7. AH1 of the molded fan and ΔH2 of the molded housing are measured according to the measure method as mentioned above, and recorded in Table 2.

TABLE 1a
Composition of inventive examples

| | EX1 | EX2 | EX3 | EX4 | EX5 | EX6 | EX7 | EX8 | EX9 |
|---|---|---|---|---|---|---|---|---|---|
| H-PP1 | 77 | 67 | 67 | 67 | 61 | | | | |
| H-PP2 | | | | | | 61 | 61 | 61 | 61 |
| H-PP3 | | | | | | | | | |
| C1 | 1 | 1 | 1 | 1 | 2 | 2 | 2 | 2 | 2 |
| C2 | | | | | | | | | |
| C3 | | | | | | | | | |
| C4 | | | | | | | | | |
| RF1 | 10 | 10 | 15 | 20 | 25 | 25 | | | |
| RF2 | | | | | | | 25 | | |
| RF3 | | | | | | | | 25 | |
| RF4 | | | | | | | | | 25 |
| P1 | 10 | 20 | 15 | 10 | 10 | 10 | 10 | 10 | 10 |
| P2 | | | | | | | | | |
| P3 | | | | | | | | | |
| AC | 1.4 | 1.4 | 1.4 | 1.4 | 1.4 | 1.3 | 1.4 | 1.4 | 1.4 |
| AA | 0.2 | 0.20 | 0.20 | 0.20 | 0.20 | 0.20 | 0.20 | 0.20 | 0.20 |
| SA | | | | | | | | | |
| AO1 | 0.2 | 0.20 | 0.20 | 0.20 | 0.20 | 0.20 | 0.20 | 0.20 | 0.20 |
| AO2 | 0.2 | 0.20 | 0.20 | 0.20 | 0.20 | 0.30 | 0.20 | 0.20 | 0.20 |

TABLE 1b
Composition of inventive examples

| | EX10 | EX11 | EX12 | EX13 | EX14 | EX15 | EX16 | EX17 | EX18 |
|---|---|---|---|---|---|---|---|---|---|
| H-PP1 | | | | | | | | | |
| H-PP2 | 61 | 61 | 61 | 60 | 61 | 62 | 28 | 25 | |
| H-PP3 | | | | | | | 28 | 31 | 56 |
| C1 | 2 | 2 | | | | 1 | 2 | 2 | 2 |
| C2 | | | 2 | | | | | | |
| C3 | | | | 3 | | | | | |
| C4 | | | | | 2 | | | | |
| RF1 | 25 | 25 | 25 | 25 | 25 | 25 | 27 | 27 | 20 |
| RF2 | | | | | | | | | |
| RF3 | | | | | | | | | |
| RF4 | | | | | | | | | |
| P1 | | | 10 | 10 | 10 | 10 | 13 | 13 | 20 |
| P2 | 10 | | | | | | | | |
| P3 | | 10 | | | | | | | |
| AC | 1.4 | 1.4 | 1.3 | 1.3 | 1.3 | 1.4 | 1.1 | 1.1 | 1.1 |
| AA | 0.20 | 0.20 | 0.20 | 0.20 | 0.20 | 0.20 | 0.20 | 0.20 | 0.20 |
| SA | | | | | | | 0.30 | 0.30 | 0.30 |
| AO1 | 0.20 | 0.20 | 0.20 | 0.20 | 0.20 | 0.20 | 0.20 | 0.20 | 0.20 |
| AO2 | 0.20 | 0.20 | 0.30 | 0.30 | 0.30 | 0.20 | 0.20 | 0.20 | 0.20 |

H-PP1 is the commercial propylene homopolymer “HF955MO” of Borealis AG (Austria) with a MFR₂ (230° C.) of 20 g/10 min and a melting point of 165° C.;
H-PP 2 is the commercial propylene homopolymer “HG385MO” of Borouge (Abu Dabi) with a MFR₂ (230° C.) of 25 g/10 min and a melting point of 161° C.;
H-PP 3 is the commercial propylene homopolymer “HJ325MO” of Borouge (Abu Dabi) with a MFR₂ (230° C.) of 50 g/10 min and a melting point of 160° C.;
C 1 is the commercial maleic anhydride grafted polypropylene “Exxelor PO 1020” of ExxonMobil Chemical (Belgium) with a maleic anhydride content of 1.1 wt.-% and a MFR₁ (190° C.) of 125 g/10 min;
C 2 is the commercial maleic anhydride grafted polypropylene “Bondyam 1010” of Polyram Ram-On Industries (Israel) with a maleic anhydride content of 1.0 wt.-% and a MFR₁ (190° C.) of 200 g/10 min;
C 3 is the commercial maleic anhydride grafted polypropylene “CMG 5001-H” of Shanghai SUNNY New Technology Development Co., Ltd, (China) with a maleic anhydride content of 0.9 wt.-% and a MFR₁ (190° C.) of 250 g/10 min;
C 4 is the commercial gycidyl methacrylate grafted isotactic polypropylene (GMA-g-PP) of Dupont (USA) with a gycidyl methacrylate content of 6.0 wt.-% and a MFR₁ (190° C.) of 50 g/10 min;
RF 1 is the commercial glass fiber “ECS305K-4.5” of Chongqing Polycomp International Corposartion (China) with a diameter of 13.0 μm and a length of 4.5 mm;
RF 2 is the commercial glass fiber “147A-14P“ of Owens-Corning Composites LLC (USA) with a diameter of 13.7 μm and a length of 4.0 mm;
RF 3 is the commercial glass fiber “ECS10-3.0-T438” of Taishan Fiberglass INC (China) with a diameter of 10.0 μm and a length of 3.0 mm;
RF 4 is the commercial wollastonite “Nyglos 8” of NYCO Minerals Inc (USA) with an aspect ratio of 19/1;
P 1 is the commercial mica “Mica MB” of Luquan Anlida Powder Material Factory (China) with a cutoff particle size d95 of 10 μm and in the form of a flake;
P 2 is the commercial mica “Mica PW80” of MINELCO Oy (Finland) with a cutoff particle size d95 of 9 μm and in the form of a flake;
P 3 is the commercial talc “HTP2” of IMI FABI Talc Company (Postalesio, Italy) with a cutoff particle size d95 of 8.5 μm and in the form of a flake;
AC is the commercial polypropylene for additive mix “HC001A-B1” of Borealis, Austria with a MFR₂ (230° C.) of 2.5 g/10 min;
AA is the commercial antistatic agent “Rekimal AS-105” of RIKEVITA (MALAYSIA) SDN. BHD., Malaysia;
SA is the commercial slip agent “Armoslip E pastilles” of Akzo Nobel Polymer Chemicals B.V., Netherlands;
AO1 is the commercial antioxidant blend “Irganox B225 FF” being a blend of “Irganox 1010” (1 part) and “Irganox 168” (1 part) of BASF (China) Co. Ltd., China;
AO2 is the commercial antioxidant “Irganox PS 802 FL” of BASF (China) Co. Ltd., China;

TABLE 2a
Properties

| Property | | CE 1 | EX 1 | EX 2 | EX 3 | EX 4 | EX 5 |
|---|---|---|---|---|---|---|---|
| MFR₂ | [g/10 min] | 2 | 15.6 | 11.5 | 8.4 | 7.2 | 4.9 |
| Tensile Strength | [MPa] | 100 | 52.6 | 60.2 | 69.3 | 82.8 | 101 |
| Flexural Modulus. | [MPa] | 6000 | 4003 | 5240 | 5670 | 6100 | 7710 |
| Notched Izod (23° C.) | [kJ/m²] | 11.0 | 5.3 | 4.6 | 6.3 | 9.1 | 13.7 |
| ΔH1 | [mm] | 11.3 | — | — | — | — | — |
| ΔH2 | [mm] | 4.0 | | | | | |
| δ | [mm] | 4.2 | 1.0 | 0.7 | 0.8 | 1.1 | 1.1 |

TABLE 2b
Properties

| Property | | EX 6 | EX 7 | EX 8 | EX 9 | EX 10 | EX 11 |
|---|---|---|---|---|---|---|---|
| MFR₂ | [g/10 min] | 6.5 | 6.4 | 6.6 | 5.9 | 6.7 | 6.8 |
| Tensile Strength | [MPa] | 92.2 | 93.2 | 93.8 | 53.6 | 95.6 | 83.4 |
| Flexural Modulus. | [MPa] | 7180 | 7090 | 7136 | 5039 | 7390 | 5723 |
| Notched Izod (23° C.) | [kJ/m²] | 10.7 | 10.9 | 11.2 | 7.9 | 11.5 | 8.9 |
| ΔH1 | [mm] | 3.9 | — | — | — | — | — |
| ΔH2 | [mm] | 1.3 | | | | | |
| δ | [mm] | 1.0 | 1.2 | 1.1 | 2.6 | 1.1 | 2.2 |

TABLE 2c
Properties

| Property | | EX 12 | EX 13 | EX 14 | EX 15 | EX 16 | EX 17 | EX 18 |
|---|---|---|---|---|---|---|---|---|
| MFR₂ | [g/10 min] | 7.1 | 7.3 | 5.3 | 5.4 | 7.7 | 7.6 | 10.7 |
| Tensile Strength | [MPa] | 92.9 | 90.5 | 88.6 | 89.3 | 97.1 | 92.2 | 82.2 |
| Flexural Modulus. | [MPa] | 7290 | 6728 | 6431 | 6810 | 7590 | 7940 | 7480 |
| Notched Izod (23° C.) | [kJ/m²] | 11.2 | 9.8 | 9.6 | 8.5 | 11.1 | 10.6 | 8.9 |
| ΔH1 | [mm] | — | — | — | — | 3.7 | — | 3.8 |
| ΔH2 | [mm] | | | | | 1.0 | | 1.2 |
| δ | [mm] | 1.2 | 1.1 | 1.1 | 1.1 | 0.9 | 0.9 | 0.8 |

The comparative example (CE 1) comprises 30 wt.-% RF 1, 66.5 wt.-% of a propyle homopolymer, 3.5 wt.-% of additives, wherein the propylene homopolymer has a MFR₂ (230° C.) of 8 g/10 min and a melting point of 162° C.

TABLE 3a
Extruder conditions for preparing pellets of the compositions

| Process condition | | EX 1 | EX 2 | EX 3 | EX 4 | EX 5 | EX 6 |
|---|---|---|---|---|---|---|---|
| zone2 | [° C.] | 205 | 207 | 209 | 215 | 202 | 216 |
| zone 3 | [° C.] | 226 | 223 | 223 | 223 | 213 | 219 |
| zone 4 | [° C.] | 225 | 225 | 225 | 227 | 217 | 237 |
| zone 5 | [° C.] | 225 | 227 | 227 | 227 | 218 | 227 |
| zone 6 | [° C.] | 218 | 218 | 218 | 218 | 218 | 227 |
| zone 7 | [° C.] | 220 | 219 | 219 | 219 | 220 | 210 |
| zone 8 | [° C.] | 218 | 218 | 219 | 218 | 209 | 208 |
| zone 9 | [° C.] | 220 | 220 | 220 | 220 | 211 | 208 |
| zone 10 | [° C.] | 219 | 219 | 221 | 219 | 209 | 207 |
| zone 11 | [° C.] | 220 | 220 | 214 | 211 | 212 | 198 |
| die | [° C.] | 222 | 222 | 224 | 224 | 223 | 208 |
| melt temp. | [° C.] | 212 | 215 | 217 | 214 | 215 | 200 |
| throughput | [kg/hour] | 55 | 55 | 60 | 60 | 60 | 70 |
| screw speed | [rpm] | 400 | 400 | 450 | 450 | 407 | 407 |
| torque | [%] | 54.20 | 54.20 | 56.00 | 58.30 | 57.40 | 64.30 |
| vacuum | [MPa] | −0.06 | −0.06 | −0.06 | −0.06 | −0.06 | −0.06 |

TABLE 3b
Extruder conditions for preparing pellets of the compositions

| Process condition | | EX 7 | EX 8 | EX 9 | EX 10 | EX 11 | EX 12 |
|---|---|---|---|---|---|---|---|
| zone2 | [° C.] | 214 | 216 | 216 | 216 | 215 | 204 |
| zone 3 | [° C.] | 220 | 218 | 219 | 219 | 219 | 216 |
| zone 4 | [° C.] | 234 | 233 | 237 | 237 | 233 | 217 |
| zone 5 | [° C.] | 226 | 224 | 227 | 227 | 225 | 218 |
| zone 6 | [° C.] | 225 | 223 | 227 | 227 | 227 | 218 |
| zone 7 | [° C.] | 212 | 210 | 210 | 210 | 210 | 219 |
| zone 8 | [° C.] | 209 | 208 | 208 | 208 | 208 | 209 |
| zone 9 | [° C.] | 211 | 208 | 208 | 208 | 208 | 208 |
| zone 10 | [° C.] | 209 | 210 | 207 | 207 | 207 | 208 |
| zone 11 | [° C.] | 200 | 200 | 198 | 198 | 198 | 212 |
| die | [° C.] | 207 | 208 | 208 | 208 | 206 | 222 |
| melt temp. | [° C.] | 203 | 202 | 200 | 203 | 200 | 213 |
| throughput | [kg/hour] | 70 | 70 | 70 | 70 | 70 | 60 |
| screw speed | [rpm] | 407 | 407 | 407 | 407 | 407 | 400 |
| torque | [%] | 64.20 | 64.50 | 55.60 | 63.80 | 63.80 | 61.30 |
| vacuum | [MPa] | −0.06 | −0.06 | −0.06 | −0.06 | −0.06 | −0.06 |

TABLE 3c
Extruder conditions for preparing pellets of the compositions

| Process condition | | EX 13 | EX 14 | EX 15 | EX 16 | EX 17 | EX 18 |
|---|---|---|---|---|---|---|---|
| zone2 | [° C.] | 205 | 203 | 216 | 206 | 205 | 201 |
| zone 3 | [° C.] | 218 | 220 | 219 | 213 | 214 | 211 |
| zone 4 | [° C.] | 218 | 219 | 223 | 220 | 219 | 215 |
| zone 5 | [° C.] | 219 | 215 | 227 | 216 | 215 | 211 |
| zone 6 | [° C.] | 219 | 221 | 227 | 223 | 221 | 214 |
| zone 7 | [° C.] | 220 | 221 | 213 | 218 | 219 | 215 |
| zone 8 | [° C.] | 210 | 216 | 208 | 217 | 220 | 214 |
| zone 9 | [° C.] | 209 | 213 | 208 | 211 | 210 | 206 |
| zone 10 | [° C.] | 207 | 204 | 207 | 203 | 204 | 198 |
| zone 11 | [° C.] | 211 | 216 | 198 | 217 | 216 | 211 |
| die | [° C.] | 217 | 218 | 208 | 219 | 218 | 213 |
| melt temp. | [° C.] | 214 | 216 | 200 | 217 | 215 | 210 |
| throughput | [kg/hour] | 60 | 60 | 70 | 60 | 60 | 60 |
| screw speed | [rpm] | 400 | 400 | 407 | 400 | 400 | 400 |
| torque | [%] | 60.80 | 62.30 | 64.30 | 62.30 | 62.30 | 62.30 |
| vacuum | [MPa] | −0.06 | −0.06 | −0.06 | −0.06 | −0.06 | −0.06 |

TABLE 4a
Molding process parameters for the specimen
for measuring mechanical property

| Temperature profile | | CE 1 | EX 1 | EX 2 | EX 3 | EX 4 | EX 5 |
|---|---|---|---|---|---|---|---|
| Zone 1 | [° C.] | 230 | 210 | 210 | 220 | 220 | 220 |
| Zone 2 | [° C.] | 230 | 210 | 215 | 225 | 225 | 230 |
| Zone 3 | [° C.] | 220 | 205 | 205 | 220 | 220 | 220 |
| Nozzle | [° C.] | 225 | 210 | 210 | 215 | 215 | 220 |
| Injecting Speed | [mm/s] | 10 | 10 | 10 | 10 | 10 | 10 |
| Holding time | [s] | 35 | 35 | 35 | 35 | 35 | 35 |
| in the mold | | | | | | | |
| Cooling time | [s] | 25 | 25 | 25 | 25 | 25 | 25 |
| Holding pressure | [bar] | 55 | 55 | 55 | 55 | 55 | 55 |
| in the mold | | | | | | | |
| Back pressure in | [bar] | 6 | 5 | 5 | 5 | 5 | 5 |
| plasticizing part | | | | | | | |

TABLE 4b
Molding process parameters for the specimen
for measuring mechanical property

| | | EX | EX | EX | EX | EX | EX |
|---|---|---|---|---|---|---|---|
| Temperature profile | | 6 | 7 | 8 | 9 | 10 | 11 |
| Zone 1 | [° C.] | 220 | 220 | 220 | 220 | 220 | 220 |
| Zone 2 | [° C.] | 225 | 225 | 225 | 225 | 225 | 225 |
| Zone 3 | [° C.] | 220 | 220 | 220 | 220 | 220 | 220 |
| Nozzle | [° C.] | 215 | 215 | 215 | 215 | 215 | 215 |
| Injecting Speed | [mm/s] | 10 | 10 | 10 | 10 | 10 | 10 |
| Holding time | [s] | 35 | 35 | 35 | 35 | 35 | 35 |
| in the mold | | | | | | | |
| Cooling time | [s] | 25 | 25 | 25 | 25 | 25 | 25 |
| Holding pressure | [bar] | 55 | 55 | 55 | 55 | 55 | 55 |
| in the mold | | | | | | | |
| Back pressure in | [bar] | 5 | 5 | 5 | 5 | 5 | 5 |
| plasticizing part | | | | | | | |

TABLE 4c
Molding process parameters for the specimen
for measuring mechanical property

| Temperature | | EX | EX | EX | EX | EX | EX | EX |
|---|---|---|---|---|---|---|---|---|
| profile | | 12 | 13 | 14 | 15 | 16 | 17 | 18 |
| Zone 1 | [° C.] | 220 | 220 | 220 | 220 | 220 | 220 | 210 |
| Zone 2 | [° C.] | 225 | 225 | 230 | 230 | 225 | 225 | 215 |
| Zone 3 | [° C.] | 220 | 220 | 220 | 220 | 220 | 220 | 205 |
| Nozzle | [° C.] | 215 | 215 | 220 | 220 | 215 | 215 | 210 |
| Injecting | [mm/s] | 10 | 10 | 10 | 10 | 10 | 10 | 10 |
| Speed | | | | | | | | |
| Holding time | [s] | 35 | 35 | 35 | 35 | 35 | 35 | 35 |
| in the mold | | | | | | | | |
| Cooling time | [s] | 25 | 25 | 25 | 25 | 25 | 25 | 25 |
| Holding | [bar] | 55 | 55 | 55 | 55 | 55 | 55 | 55 |
| pressure in | | | | | | | | |
| the mold | | | | | | | | |
| Back | [bar] | 5 | 5 | 5 | 5 | 5 | 5 | 5 |
| pressure in | | | | | | | | |
| plasticizing | | | | | | | | |
| part | | | | | | | | |

TABLE 5a
Molding process parameters for the sheet for testing δ-warpage

| Temperature profile | | CE 1 | EX 1 | EX 2 | EX 3 | EX 4 | EX 5 |
|---|---|---|---|---|---|---|---|
| Zone 1 | [° C.] | 230 | 210 | 210 | 220 | 220 | 220 |
| Zone 2 | [° C.] | 230 | 210 | 215 | 225 | 225 | 230 |
| Zone 3 | [° C.] | 220 | 205 | 205 | 220 | 220 | 220 |
| Nozzle | [° C.] | 225 | 210 | 210 | 215 | 215 | 220 |
| Injecting Speed | [mm/s] | 30 | 30 | 30 | 30 | 30 | 30 |
| Holding time | [s] | 8 | 8 | 8 | 8 | 8 | 8 |
| in the mold | | | | | | | |
| Cooling time | [s] | 25 | 25 | 25 | 25 | 25 | 25 |
| Holding pressure | [bar] | 65 | 65 | 65 | 65 | 65 | 65 |
| in the mold | | | | | | | |
| Back pressure in | [bar] | 8 | 8 | 8 | 8 | 8 | 8 |
| plasticizing part | | | | | | | |

TABLE 5b
Molding process parameters for the sheet for testing δ-warpage

| Temperature | | EX | EX | EX | EX | EX | EX | EX |
|---|---|---|---|---|---|---|---|---|
| profile | | 6 | 7 | 8 | 9 | 10 | 11 | 12 |
| Zone 1 | [° C.] | 220 | 220 | 220 | 220 | 220 | 220 | 220 |
| Zone 2 | [° C.] | 225 | 225 | 225 | 225 | 225 | 225 | 225 |
| Zone 3 | [° C.] | 220 | 220 | 220 | 220 | 220 | 220 | 220 |
| Nozzle | [° C.] | 215 | 215 | 215 | 215 | 215 | 215 | 215 |
| Injecting | [mm/s] | 30 | 30 | 30 | 30 | 30 | 30 | 30 |
| Speed | | | | | | | | |
| Holding time | [s] | 8 | 8 | 8 | 8 | 8 | 8 | 8 |
| in the mold | | | | | | | | |
| Cooling time | [s] | 25 | 25 | 25 | 25 | 25 | 25 | 25 |
| Holding | [bar] | 65 | 65 | 65 | 65 | 65 | 65 | 65 |
| pressure in | | | | | | | | |
| the mold | | | | | | | | |
| Back | [bar] | 8 | 8 | 8 | 8 | 8 | 8 | 8 |
| pressure in | | | | | | | | |
| plasticizing | | | | | | | | |
| part | | | | | | | | |

TABLE 5c
Molding process parameters for the sheet for testing δ-warpage

| Temperature profile | | EX13 | EX14 | EX15 | EX16 | EX17 | EX18 |
|---|---|---|---|---|---|---|---|
| Zone 1 | [° C.] | 220 | 220 | 220 | 220 | 220 | 210 |
| Zone 2 | [° C.] | 225 | 230 | 230 | 230 | 230 | 215 |
| Zone 3 | [° C.] | 220 | 220 | 220 | 220 | 220 | 205 |
| Nozzle | [° C.] | 215 | 220 | 220 | 220 | 220 | 210 |
| Injecting Speed | [mm/s] | 30 | 30 | 30 | 30 | 30 | 30 |
| Holding time | [s] | 8 | 8 | 8 | 8 | 8 | 8 |
| in the mold | | | | | | | |
| Cooling time | [s] | 25 | 25 | 25 | 25 | 25 | 25 |
| Holding pressure | [bar] | 65 | 65 | 65 | 65 | 65 | 65 |
| in the mold | | | | | | | |
| Back pressure in | [bar] | 8 | 8 | 8 | 8 | 8 | 8 |
| plasticizing part | | | | | | | |

TABLE 6
Molding process parameters for the fan

| | | CE 1 | EX 6 | EX 16 | EX 18 |
|---|---|---|---|---|---|
| Temperature profile | | | | | |
| Zone 1 | [° C.] | 230 | 220 | 220 | 220 |
| Zone 2 | [° C.] | 220 | 210 | 210 | 210 |
| Zone 3 | [° C.] | 210 | 210 | 210 | 210 |
| Zone 4 | [° C.] | 200 | 210 | 205 | 205 |
| Zone 5 | [° C.] | 190 | 190 | 190 | 190 |
| Nozzle | [° C.] | 230 | 230 | 230 | 230 |
| Average Injecting Speed | [mm/s] | 40 | 45 | 45 | 45 |
| Holding time in the mold | [s] | 6 | 6 | 6 | 6 |
| Cooling time | [s] | 30 | 30 | 30 | 30 |
| Holding pressure in the mold | [bar] | 60 | 55 | 55 | 55 |
| Back pressure in | [bar] | 12 | 12 | 12 | 12 |
| plasticizing part | | | | | |

TABLE 7
Molding process parameters for the housing of generator

| | | CE 1 | EX 6 | EX 16 | EX 18 |
|---|---|---|---|---|---|
| Temperature profile | | | | | |
| Zone 1 | [° C.] | 225 | 215 | 215 | 215 |
| Zone 2 | [° C.] | 215 | 205 | 205 | 205 |
| Zone 3 | [° C.] | 205 | 205 | 205 | 205 |
| Zone 4 | [° C.] | 195 | 205 | 200 | 200 |
| Zone 5 | [° C.] | 185 | 185 | 185 | 185 |
| Nozzle | [° C.] | 225 | 225 | 225 | 225 |
| Average Injecting Speed | [mm/s] | 35 | 35 | 35 | 35 |
| Holding time in the mold | [s] | 6 | 6 | 6 | 6 |
| Cooling time | [s] | 30 | 30 | 30 | 30 |
| Holding pressure in the mold | [bar] | 55 | 50 | 50 | 50 |
| Back pressure in | [bar] | 12 | 12 | 12 | 12 |
| plasticizing part | | | | | |

1. A moulded article comprising a composition (Co), wherein said composition (Co) comprises
(a) a propylene homopolymer (H-PP) having a melt flow rate MFR₂ (230° C.) measured according to ISO 1133 of at least 5.0 g/10 min;
(b) a non-spherical reinforcing material (RF);
(c) a phyllosilicate (P); and
(d) a compatibilizer (C).

2. The moulded article according to claim 1, wherein said moulded article comprises based on the total amount of the moulded article at least 85 wt.-% of the composition (Co).

3. The moulded article according to claim 1, wherein the moulded article and/or the composition (Co) has/have a melt flow rate MFR₂ (230° C.) measured according to ISO 1133 of at least 3.0 g/10 min.

4. The moulded article according to claim 1, wherein the moulded article and/or the composition (Co) has/have
(a) a flexural modulus measured according to ISO 178 of at least 4000 MPa;
and/or
(b) a tensile strength measured according to ISO 527-2 of at least 52 MPa;
and/or
(c) an Izod impact strength (23° C.) measured according to ISO 180 of at least 4.6 kJ/m².

5. The moulded article according to claim 1, wherein the homopolmyer (H-PP)
(a) has a melting temperature measured according to ISO 11357-3 of at least 150° C.;
and/or
(b) is α-nulceated.

6. The moulded article according to claim 1, wherein the non-spherical reinforcing material (RF) has an aspect ratio from 5 to 400, wherein optionally the reinforcing material (RF) has
(a) a length from 0.1 to 3.0 mm;
and/or
(b) a diameter from 8 to 20 μm.

7. The moulded article according to claim 1, wherein the non-spherical reinforcing material (RF) is selected from the group consisting of glass fibre (GF), carbon fibre (CF), and wollastonite (WL).

8. The moulded article according to claim 1, wherein the phyllosilicate (P) has a cutoff particle size d95 [mass percent] determined by sedimentation technique in the range of 3.5 to 50.0 μm.

9. The moulded article according to claim 1, wherein the phyllosilicate (P) is selected from the group consisting of mica, kaolinite, montmorillonite and talc.

10. The moulded article according to claim 1, wherein the compatibilizer (C) is a graft or block α-olefin copolymer having a polar group of carboxylic acid or carboxylic acid anhydride.

11. The moulded article according to claim 1, wherein the compatibilizer (C) is a maleic anhydride functionalized polypropylene.

12. The moulded article according to claim 1, wherein the composition (Co) comprises
(a) 50 to 80 wt.-% of the propylene homopolymer (H-PP);
(b) 10 to 30 wt.-% of the non-spherical reinforcing material (RF);
(c) 5 to 25 wt.-% of the phyllosilicate (P); and
(d) 0.5 to 5 wt.-% of the compatibilizer (C).

13. The moulded article according to claim 1, wherein the moulded article is an injection moulded article.

14. The moulded article according to claim 1, wherein the moulded article is selected from the group consisting of a fan, a part of a fan, a leaf of a fan, housing of a generator, a base plate and a backrest of a plastic chair.

15. A composition (Co) for a moulded article to reduce warpage, wherein said composition (Co) comprises
(a) a propylene homopolymer (H-PP) having a melt flow rate MFR₂ (230° C.) measured according to ISO 1133 of at least 5.0 g/10 min;
(b) a non-spherical reinforcing material (RF);
(c) a phyllosilicate (P); and
(d) a compatibilizer (C).

16. The composition according to claim 15, wherein the warpage defined as the δ-warpage is equal or below 2.6 mm.

17. The composition according to claim 15, wherein the composition (Co) comprises
(a) 50 to 80 wt.-% of the propylene homopolymer (H-PP);
(b) 10 to 30 wt.-% of the non-spherical reinforcing material (RF);
(c) 5 to 25 wt.-% of the phyllosilicate (P); and
(d) 0.5 to 5 wt.-% of the compatibilizer (C).
and/or
wherein said moulded article comprises at least 85 wt.-% of the composition (Co) based on the total amount of the moulded article.

18. The moulded article according to claim 1, wherein the non-spherical reinforcing material (RF) is a glass fibre (GF).

19. The moulded article according to claim 1, wherein the phyllosilicate (P) is mica.

20. A composition (Co) in an injection moulded article to reduce warpage, wherein said composition (Co) comprises
(a) a propylene homopolymer (H-PP) having a melt flow rate MFR₂ (230° C.) measured according to ISO 1133 of at least 5.0 g/10 min;
(b) a non-spherical reinforcing material (RF);
(c) a phyllosilicate (P); and
(d) a compatibilizer (C).
